(19) United States
(12) Patent Application Publication
(10) Pub. No.: US 2020/0349547 A1
(43) Pub. Date: Nov. 5, 2020

(54) SECURE IDENTIFICATION SYSTEM USING SMARTPHONES

(71) Applicant: Centro de Pesquisas Avançadas Wernher von Braun, Sao Paulo (BR)

(72) Inventors: Dario Sassi Thober, São Paulo (BR); Diogo Melo, São Paulo (BR); Jorge Felix Herrera, São Paulo (BR); Vital Cruvinel, São Paulo (BR)

(73) Assignee: Centro de Pesquisas Avançadas Wernher von Braun, Sao Paulo (BR)

(21) Appl. No.: 16/855,426

(22) Filed: Apr. 22, 2020

(30) Foreign Application Priority Data
May 3, 2019 (BR) BR102019009094-4
Aug. 15, 2019 (BR) 102019017040-9

(51) Int. Cl. G06Q 20/32; H04W 12/00; H04L 9/14; H04L 9/08; G06Q 20/38; H04W 4/80

(52) U.S. Cl. CPC G06Q 20/327; H04W 12/0013; H04L 9/14; H04L 2209/56; G06Q 20/382; H04W 4/80; H04L 9/0819

(57) ABSTRACT

Within the scope of the Internet of Things, this application helps to provide secure identification, both of users and of their vehicles, while also allowing to establish efficient communication with ad-hoc equipment installed in the environment in order to detect their presence, including those operating at high speed at the time of its passage, in the case of vehicles, for example. This would remove the need for a tag device (Win, Bluetooth, RFID or others) installed inside the vehicle to establish secure wireless detection, since this detection process would be performed through the cell phone itself, reducing infrastructure costs on both sides: at toll points and service payment systems as well as to the end customer.

### FIELD OF APPLICATION

This descriptive report on the invention patent refers to the secure identification system using a smartphone, with a transponder function, known as Virtual Tag, which operates in the context of the Internet of Things (IoT), and whose main quality is its secure interoperability with existing systems, This interoperability is based on the use of encryption keys and protocols compatible with the IoT technology in use in Brazil based on UHF RFD technology with secure commands for reading and writing data, on which, for example, the electronic toll operations of ARTESP (São Paulo State Transport Agency) are based. The user's mobile device is thus transformed into a Virtual Tag that can be used in a set of applications and environments in both existing and future IoT networks, at all times in ways that are compatible with data processing systems (messaging services and BackOffice for generation and maintenance of security keys and other systemic functionalities used in the mentioned RFD systems in operation). The functionality of Virtual Tags, both in the context of secure identification of the device and/or vehicle itself, as well as that of IoT networks, is implemented based on a set of libraries that allow operation on different computing platforms and easy integration with existing applications (not only those in use in national territory, but also other international ones based on Blockchain technology), thus enabling the creation of new secure applications for uses in collection, security, logistics, electronic inspection, among others, such as, for example, the automatic identification of vehicles and people, including vehicles at high speed, both on highways, tolls, self-service stations, restaurants, including the monitoring of objects of all kinds (things) through the cell phone itself, which serves at the same time as an identification transponder, and all types of applications in which access to controlled areas and sale of products and/or services can be based on programmable cell phones that have connectivity features such as Bluetooth and WiFi. The Virtual Tag then acts both as a transponder, sending its identification in a secure manner, and also as a reader of other Virtual Tags and IoT networks.

### SUMMARY OF THE INVENTION

With the secure identification system, it is possible to not only identify the cell phone, and therefore, its owner, but also to establish efficient communication with the equipment that may be identifying the environment through which the cell phone passes, even at high speed at the moment of its passage, in the case of vehicles.

The present invention eliminates the need for a tag device (WiFi, Bluetooth, RFID or others) installed in the vehicle to establish secure wireless detection, which will be done by the cell phone itself, reducing infrastructure costs on both sides; at toll points and the like, as well as for the end customer. On the other hand, the invention would make it possible to identify the objects (things) to which the ha devices are linked, expanding the spectrum of applications and uses of the cell phone by providing both applications designed for this purpose, as well as libraries for implementing virtual tags in the construction of new infrastructures.

Based on the present invention, the toll operator, with personalized service, or similar, can replace the RFID technology with a less expensive, more secure and wireless installation, based on WiFi and Bluetooth, taking advantage of the wireless technology present in cell phones to implement identification linked to the vehicle or to the person, who can use just their cell phone as a mobile identity device, without the need for any additional hardware, for the purpose of having access and identification and payment options.

### FUNDAMENTALS OF THE INVENTION

There are basically four lines of services and/or products for which the present invention represents evolution:

In the use of RFID systems for identification and/or safe inspection of vehicles, for example, in Automatic Vehicle Identification (AVI) on free-flow lanes on toll roads, where vehicles move at medium or high speed, whose highway infrastructure cost is high, in addition to requiring the installation of tags or transponders on the vehicles;

For mobile payments, where the user is charged for a product or service at a point of sale, at zero speed, or at a stop-and-go solution, and which may also require user interaction.

For fleet management and vehicle location in car parks whose identification is made via BLE or WiFi Beacons installed in the vehicles.

In personalized service environments, such as: restaurants, cafes and other spaces where the customer must be precisely identified.

In the cases mentioned above, at one end of the spectrum, in AVI systems, transponders are used as elements to facilitate communication with the highway infrastructure, and to deal with stop-and-go, as well as free-flow vehicle passages; conversely, at the other end, mobile payment is used at zero speed points of sale, and not as a vehicle identification device.

There are two major problems that are solved by this invention, taking into account the current transponder solutions for AVI use, and the mobile payment alternative in use:

First, the precise and secure location of mobile devices during the detection by the infrastructure of points of sale or access control points, necessary for tolls, parking lots, restaurants and other applications;

Second, the systemic secure and interoperable connection of mobile payment systems and solutions with automated toll collection, service payment and identification systems.

Based on this invention, these problems are solved with the use of low cost Beacon devices (such as WiFi, Bluetooth etc.) distributed to provide the unequivocal location of a vehicle on the road, a person at a restaurant table, etc., thus allowing the correct collection or inspection to occur at the time of their passage or service charge.

In addition to the precise location of the mobile device in the field of operations, the present invention also comprises a secure connection and identifiable association between the mobile device and the Beacons arranged in the places where the identification must occur. This secure association is translated into hardware and software/automatic message format, fully compatible with current AVI systems, thus making this solution immediately applicable to all private and public services offered that are based on MID and other transponders.

### DESCRIPTION OF THE INVENTION

The present system consists of a set of software components, prepared in several layers (needed to securely manage payment transactions originating from the user's cell phone), which are included in a smartphone application and include:

A mobile communication module, to manage the interaction with interconnected systems, such as track equipment, shared order and payment systems, and legacy systems.

A secure mechanism for exchanging and storing application keys and other sensitive data so as to protect the application against digital thieves and cloning.

The Smartphone Reading System (SLS), installed on the track or on the local infrastructure to interact with payment systems.

The communication module, which implements a set of communication protocols at the application level for the purpose of managing the solution's interaction with external networks.

The endpoints used by the solution include:

Client-side implementation for the solution configuration process, using a common Internet channel to exchange data with the main server in order to register, log in and manage the connection status while the application is online, without any need for the communication channel with the payment system to be active for the configuration process.

Short-range network, based on interaction via Bluetooth low-energy protocol, or WiFi, as a data transport base, in which the cell phone application interacts with the track elements and provides sufficient information to complete the payment transaction.

Security mechanisms include secure protocols for exchanging keys with the main server and SLS subsystem, also including a secure data area in the mobile application to store protocol keys, passwords and other sensitive data, which will be encrypted using a secure pair of keys during service registration.

The Smartphone Reading System (SLS) has two basic functions:

To receive the security keys sent by a centralized key server, with the key exchange mechanism using the general security paradigm in mobile systems. The keys are needed to encrypt and decrypt data that is being transmitted, in order to prevent signal or transaction fraud,

To receive the data transmitted by a mobile payment application, including the identification of the user, the vehicle and the identification location, used to charge the user who purchases the product or service.

The solution is fully integrated with current automated messaging systems that integrate and connect concessionaires, toll operators and service providers in general (public or private), as well as solution providers that need to initialize devices (RFD tags) or mobile devices.

According to the system being proposed, the activated WiFi/BLE Beacons are distributed at the operations site in order to locate the vehicle based on the RSSI and the Secure ID (of each Beacon). The effective distance between the Beacons and the geometric distribution depends on the speed of the vehicle, which, in turn, depends on the type of service that is being purchased (toll, drive-thru, parking, etc.).

The RSSI and the secure ID provided by each Beacon provide sufficient resolution between vehicles or between people in a small environment, for example, at a restaurant table, which helps in avoiding problems arising from incorrect identification. Beacons are installed according to the configuration of the environment, as in the case of detecting vehicles in motion where the number of Beacons and the distance that separates them increases when the speed of the vehicle is greater. Another example, in the case of restaurants, would be placing a Beacon in each place where the customer can be accurately identified.

The flow of detection of vehicle or individual transactions occurs according to the following schedule:

The Beacons continuously emit a short-range Bluetooth Low Energy (BLE) data pack, 1-10 Hz, to smartphones in the, entrance, or environment area,

The client is recognized when entering the area by detecting and reading the Beacon data pack from any of the sending Beacons.

As soon as the entrance area is detected, the cell phone application begins to send a BLE signal to be read by the SLS system, which contains the data that identifies the vehicle or person present in the environment.

The identification is made using the virtual tag's OBUID. This identifier is generated by the Key Management system (EGC) and derived from the Artifact Protocol (PA) used in ARTESP's electronic toll system.

Optionally, it is possible to use the “MAC address” of the user's vehicle which is associated with the OBUID of the virtual tag that identifies the user to include the vehicle's identity in the transaction.

The acquisition of data from mobile applications on the smartphone is relayed by the SLS system to payment systems integrated with the SLS.

The SLS is composed of the local computer, which has the interface firmware needed to communicate with the Messaging and Key Management (EGC) systems, and a WiFi/BLE device, which reads the cell phone and the Beacons distributed in the operating area under a secure communication protocol.

The structure of the “Beacon presence” pack, issued by the Beacon, includes:

The “COMPANY ID” (identifier of the developing company)-for testing purposes, it can be 0×FFFF, which is officially allowed by BLUETOOTH SIG (Special Interest Group).

The “COMPANY ID” for final products CANNOT be 0×FFFF

The “VBL ADVERTISING DATA” has the format:

2 BYTES: Project ID=“eH”—logistics; “eS”—Stop & Go; “eD”—Drive Thru, etc. Used to identify the algorithm to be employed in order to classify the user's position in the environment.

2 BYTES: Manufacturer; e.g.: “AA”.

4 BYTES: GROUP ID.

16 BYTES: ENCRYPTED data with AES-128; this field is subdivided into:

2 BYTES: Manufacturer.

4 BYTES: DEVICE ID.

2 BYTES: RFU (Reserved for Future Use).

4 BYTES: COUNTER; started at zero (when the Beacon is started for the first time) and increased every second.

4 BYTES: GROUP ID.

The structure of the user identification package is defined according to the specification of the Artifact Protocol used in the toll system, and includes:

The “COMPANY ID” for non-final products.

The “ADVERTISING DATA VIRTUAL TAG”, with the format:

2 BYTES: “PROJECT ID” project identifier ‘cA’ for Android and ‘cl’ for iPhone.

3 BYTES: GROUP ID Virtual Tag.

16 BYTES: Data encrypted with AES-128; this field is subdivided into:

5 BYTES: OBU-ID40.

11 BYTES: 11 most significant bytes of encrypted Beacon data.

5 BYTES: 5 least significant bytes of encrypted Beacon data.

1 BYTE: least significant byte of Beacon's “GROUP ID”.

The identification of a key's group or the GROUP ID, used to encrypt a group of devices.

The Beacon's advertising package with the Beacon's encrypted block and. GROUP ID.

An encrypted data payload called the Encrypted Block, containing the vehicle identification (OBU-ID40) and part of the Beacon's encrypted block, which after decryption, contains the data structure specified in the description of the Artifact Protocol, with the OBU-ID40 element that uniquely identifies the smartphone being the main information transmitted.

The first byte of the GROUP ID can be used to identify the coverage area (2 bits) and distance from the charging device (6 bits). This structure allows the smartphone application to obtain its approximate location.

The present invention may be applied to all services based on automated vehicle identification, such as:

Integration of mobile payment systems with the domain of AVI systems, making it possible to assign fiscal and/or payment responsibilities to vehicle traffic.

Implementation of free-flow payment models and similar application scenarios.

Stop-and-go services, such as drive-thru restaurants, gas stations and automated parking lots.

Payment for services such as restaurants, cafes, and any other where the customer must be precisely identified.

Interoperability with current RFID-based solutions used in tolls and access points, serving as a secondary vehicle identification channel in the same way as other technologies, such as OCR systems, for example.

Optimization of traffic control at intersections, where SLS are installed on intersection roads in order to measure the passage of vehicles and control the timing of traffic lights according to the measured flow.

1. A secure identification system using a smartphone comprising:
a mobile communication module, to manage the interaction with interconnected systems including a track equipment, legacy systems, and a centralized key storage with secure data transfer protocols as needed;
a secure mechanism for exchanging and storing application keys and other sensitive data to protect the application against digital thieves and cloning, and
a smartphone reading system (SLS) installed on the track or local infrastructure to interact with payment systems.

2. The system, according to claim 1, wherein the communication module implements a set of application-level communication protocols to manage the solution's interaction with external applications.

3. The system, according to claim 2 wherein the endpoints used include:
a client-side implementation for the solution configuration process, using a common Internet channel to exchange data with the main server to register, log in and manage the user's session status in the application when the application is online, without the need for the communication channel to be active at the time of the payment process, and
a short-range network, based on interaction via Bluetooth low energy protocol as a data transport base, in which the cell phone application interacts with environment elements and provides sufficient information to complete the payment transaction.

4. The system, according to claim 1, wherein the security mechanisms include secure protocols for exchanging keys with the main server and the SLS system, also including a secure data area in the mobile application to store the protocol keys, passwords and other sensitive data, which will be encrypted using a secure pair of keys during service registration.

5. The system, according to claim 1, wherein the smartphone reading system (SLS) has the basic functions of:
receiving security keys sent by a centralized key server, and applying general security to the mobile system with this key exchange mechanism, wherein the keys are required to encrypt and decrypt data that is being transmitted to prevent signal or transaction fraud,
validating the identity of the Beacon that gave rise to the transaction and the validity of its package, and
receiving data transmitted by a mobile payment application, including the identification of users and vehicles, used to charge the user who purchases the product or service.

6. The system, according to claim 1, wherein the WiFi/BLE beacons are distributed at the operations site in order to locate the vehicle based on the RSSI and the secure ID (of each beacon), the effective distance between the Beacons and the geometric distribution depend on the speed of the vehicle, which, in turn, depends on the type of service being purchased.

7. The system, according to claim 6, wherein the RSS1 and the secure ID provided by each beacon offer sufficient resolution between vehicles or individuals, in order to avoid cases of incorrect identification, the beacons are installed at appropriate positions and distances, according to the vehicle's detection speed requirements or space requirements for the environment in which the service is provided.

8. The system according to claim 1, wherein the flow of detection of transactions, in the case of vehicles, occurs according to the following schedule of events:
the beacons continuously emit a bluetooth low energy (BLE) or WiFi short-range data pack to vehicles in the entrance area;
the vehicle recognizes when it is entering the area by detecting and reading the Beacon data pack from any of the sending beacons;
as soon as the entrance area is detected, the cell phone application begins to send a BLE signal to be read by the SLS system, which contains the data that identifies the passing vehicle, and
the acquisition of data from mobile applications in the vehicle is relayed by the SLS system to payment systems integrated with the SLS system.

9. The system according to claim 8, wherein the initial identification of the data may use a unique identifier sent by the EGC or “MAC address” of the driver's cell phone.

10. The system according to claim 1, wherein the SLS system is composed of the local computer, which has the interface firmware needed to communicate with the messaging and key management (EGC) systems, and a WiFi/BLE device, which reads the cell phone and the Beacons distributed in the operating area under a secure communication protocol.

11. The system, according to claim 1, wherein the beacon presence pack structure includes:
the company ID or the company ID for finished products;
2 bytes: project ID=“eH,” “eS” or “eD”, among others;
2 bytes: manufacturer;
4 bytes: group ID;
16 bytes: encrypted with AES-128, subdivided in:
2 bytes: manufacturer;
4 bytes: device ID;
2 byte: RFU;
4 bytes: counter; started at zero when the beacon is started for the first time and increased every second;
4 bytes: group ID.

12. The system, according to claim 1, the structure of the vehicle identification package is derived from the specification of the artifact protocol used in the toll system, and includes:
the company for non-final products; the advertising which has the format:
2 bytes: project ID=‘cA’or ‘cl’;
3 bytes: group ID virtual tag;
16 bytes: data encrypted with AES-128, subdivided in:
5 bytes: OBU-ID40;
11 bytes: 11 MSB encrypted beacon data;
5 bytes: 5 LSB encrypted beacon data;
1 byte: beacon group ID LSB.
